(19) United States
(12) Patent Application Publication
(10) Pub. No.: US 2026/0340900 A1
(43) Pub. Date: Oct. 29, 2026

(54) Visual Effects Expressions

(71) Applicant: Google LLC, Mountain View, CA (US)

(72) Inventors: Nicolas Antoine Clement Roard, San Francisco, CA (US); John David Alan Hoford, San Jose, CA (US)

(73) Assignee: Google LLC, Mountain View, CA (US)

(21) Appl. No.: 19/398,443

(22) Filed: Nov. 24, 2025

Related U.S. Application Data
(60) Provisional application No. 63/796,772, filed on Apr. 29, 2025.

(51) Int. Cl. G06T 11/60

(52) U.S. Cl. CPC G06T 11/60

(57) ABSTRACT

Techniques are described for a computing device configured to obtain dimensional parameters for a graphical asset of a user interface for an application executing at the computing device, the dimensional parameters indicating one or more values for a visual effects expression, the visual effects expression configured to output information associated with visual effects for the graphical asset; generate rendering parameters for graphic code by at least providing the dimensional parameters as input to the visual effects expression, wherein the rendering parameters indicate one or more visual effects; generate, based on the rendering parameters, the user interface to include the graphic code that configures a visual appearance of the graphical asset of the user interface according to the one or more visual effects indicated by the rendering parameters; and output, for display, the user interface.

### CROSS-REFERENCE TO RELATED APPLICATION

This application claims the benefit of U.S. Provisional Patent Application Ser. No. 63/796,772 filed on Apr. 29, 2025, the disclosure of which is incorporated by reference herein in its entirety.

### BACKGROUND

A computing device may display graphical assets in user interfaces associated with software applications. Graphical assets for software applications may include visual elements, animation elements, or other design elements that may be used to create, enhance, and optimize a user experience within the software applications. These graphical assets may be designed to be interactive, intuitive, and visually appealing, ensuring smooth user interaction with the software application. For example, graphical assets may include an icon, button, illustration, screen graphic, font, background, texture, animation, transition, navigation element, popup, or other visual element that may be included in a user interface for a software application. Graphical assets of user interfaces may be associated with vector graphics (e.g., shape, dimension, color, theme, etc.) developed by application developers that specify visual designs for the graphical assets.

### SUMMARY

In general, this disclosure is directed towards leveraging visual effects expressions for configuring visual appearances of graphical assets of a user interface according to dynamic visual effects. Visual effects for graphical assets may include vector graphics such as drawing lines, paths, shapes, color, fills, animations; three-dimensional draw commands, scene graphs, shaders; or other graphical behaviors for displaying or otherwise rendering visual appearances of the graphical assets. Software developers may develop code for software applications that include visual effect expressions that are configured to dynamically configure visual appearances of a graphical asset for generating different versions of the graphical asset for a user interface. Visual effects expressions may include one or more mathematical expressions that output information for parameterized graphic commands (e.g., vector graphic commands, three-dimensional graphic commands, graphics processing unit shaders, three-dimensional scene graphs, etc.) based on input dimensional parameters (e.g., a dimension value of a graphical asset, a density value of a graphical asset, a color value of a graphical asset, application data of an application associated with the graphical asset, etc.), such that the parameterized graphic commands determined using the visual effects expressions may be executed as part of application code files for dynamic generation of different versions of visual appearances for graphical assets without pre-generating visual effects for visual appearances of the graphical assets or otherwise altering underlying application code.

Rather than hard-coding visual effects in software code files, a computing system, according to the techniques described herein, may provide code development tools for developers to deploy software code files that include visual effects expressions. The code development tools may provide developers a flexible and efficient way to manage complex shapes and graphics effects of graphical assets, resulting in more engaging and interactive user interfaces without extensive coding or large code files. In this way, user devices executing an application with a code file that includes a visual effects expression may dynamically output various versions of visual appearances for a graphical asset on the fly (e.g., at run-time of the application), and without developers manually creating, recompiling, or otherwise developing code for visual effects for visual appearances of the graphical asset. In other words, by integrating visual effects expressions in software application code files to separate software code development associated with a functional layer of an application and software code development associated with a presentation layer of the application, the computing system may enhance user experiences interacting with graphical assets by configuring user devices to dynamically generate and execute code for visual effects at runtime of an application, in a computationally efficient manner (e.g., consume fewer computational resources associated with obtaining and processing large code files with hard-coded visual effects that may change based on developer inputs, application data, external inputs, etc.), and/or without having developers manually code visual effects for user interfaces output during execution of an application.

In some aspects, the techniques described herein relate to a method that includes obtaining, by a computing device, a set of dimensional parameters for a graphical asset of a user interface for an application executing at the computing device, the set of dimensional parameters indicating one or more values for a visual effects expression, the visual effects expression configured to output information associated with visual effects for the graphical asset; generating, by the computing device, rendering parameters for graphic code associated with the application by at least providing the set of dimensional parameters as input to the visual effects expression, wherein the rendering parameters are associated with outputs of the visual effects expression and the rendering parameters indicate one or more visual effects; generating, by the computing device and based on the rendering parameters, the user interface to include the graphic code that configures a visual appearance of the graphical asset of the user interface according to the one or more visual effects indicated by the rendering parameters; and outputting, by the computing device and for display, the user interface.

In some aspects, the techniques described herein relate to a computing device that includes a memory; and one or more processors operably coupled to the memory, wherein the one or more processors execute instructions stored at the memory to: obtain a set of dimensional parameters for a graphical asset of a user interface for an application executing at the computing device, the set of dimensional parameters indicating one or more values for a visual effects expression, the visual effects expression configured to output information associated with visual effects for the graphical asset; generate rendering parameters for graphic code associated with the application by at least providing the set of dimensional parameters as input to the visual effects expression, wherein the rendering parameters are associated with outputs of the visual effects expression and the rendering parameters indicate one or more visual effects; generate, based on the rendering parameters, the user interface to include the graphic code that configures a visual appearance of the graphical asset of the user interface according to the one or more visual effects indicated by the rendering parameters; and output, for display, the user interface.

In some aspects, the techniques described herein relate to a computer program product for configuring visual appearances of graphical assets, the computer program product including one or more instructions that, when executed by at least one processor, cause the at least one processor to obtain a set of dimensional parameters for a graphical asset of a user interface for an application executing at a computing device, the set of dimensional parameters indicating one or more values for a visual effects expression, the visual effects expression configured to output information associated with visual effects for the graphical asset; generate rendering parameters for graphic code associated with the application by at least providing the set of dimensional parameters as input to the visual effects expression, wherein the rendering parameters are associated with outputs of the visual effects expression and the rendering parameters indicate one or more visual effects; generate, based on the rendering parameters, the user interface to include the graphic code that configures a visual appearance of the graphical asset of the user interface according to the one or more visual effects indicated by the rendering parameters; and output, for display, the user interface.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing environment for dynamically configuring visual appearances of graphical assets using visual effects expressions, in accordance with one or more aspects of the present disclosure.

FIG. 2 is a block diagram illustrating an example computing device configured to execute example graphic code including example rendering parameters created using example visual effects expressions, in accordance with one or more aspects of the present disclosure.

FIG. 3 is a block diagram illustrating an example computing system for implementing example visual effects expressions in example graphic code for one or more graphical assets, in accordance with one or more aspects of the present disclosure.

FIG. 4 is a flowchart illustrating an example operation of a computing environment configured to implement graphic code including visual effects expressions, in accordance with one or more aspects of the present disclosure.

FIG. 5 is a block diagram illustrating an example application user interface builder, in accordance with one or more aspects of the present disclosure.

FIG. 6 is a flowchart illustrating an example operation for a computing device configured to create user interfaces using visual effects expressions, in accordance with one or more aspects of the present disclosure.

### DETAILED DESCRIPTION

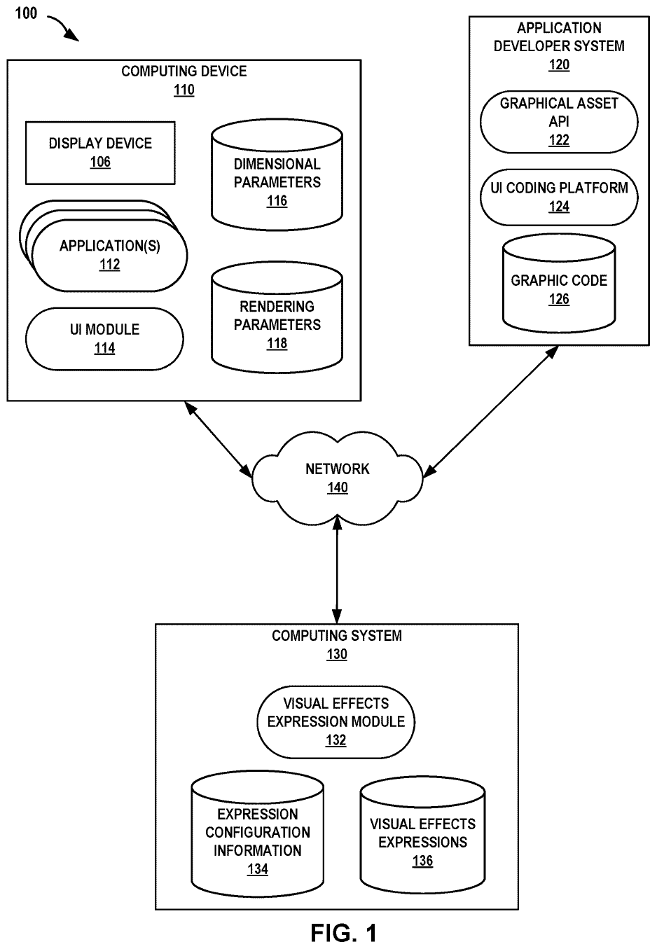

FIG. 1 is a block diagram illustrating example computing environment 100 for dynamically configuring visual appearances of graphical assets using visual effects expressions, in accordance with one or more aspects of the present disclosure. Computing environment 100 of FIG. 1 includes computing device 110, application developer system 120, and computing system 130 communicatively coupled via network 140.

Network 140 represents any public or private communications network, for instance, cellular, Wi-Fi, and/or other types of networks for transmitting data between computing systems, servers, and computing devices. For example, computing device 110 may exchange data, via network 140, with computing system 130 and/or application developer system 120. Network 140 may include one or more network hubs, network switches, network routers, or any other network equipment that are operatively inter-coupled thereby providing for the exchange of information between computing device 110, application developer system 120, and/or computing system 130. Computing device 110, application developer system 120, and computing system 130 may transmit and receive data across network 140 using any suitable communication techniques. Computing device 110, application developer system 120, and computing system 130 may each be operatively coupled to network 140 using respective network links. The links coupling computing device 110 and computing system 130 to network 140 may be Ethernet or other types of network connections and such connections may be wireless and/or wired connections.

Computing device 110 represents a mobile or non-mobile computing device. Examples of computing device 110 include user computing devices (e.g., laptops, desktops, and mobile computing devices such as tablets, smartphones, wearable computing devices, artificial intelligence glasses, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof configured to send and receive information via a network, such as network 140.

Computing device 110 may include display device 106, one or more applications 112 (also referred to herein as “applications 112”), user interface (UI) module 114, dimensional parameters 116, and rendering parameters 118. Dimensional parameters 116 may represent variables that developers may configure to dynamically encode a visual appearance associated with a graphical asset, without the developers having to write code for the visual appearance. For example, dimensional parameters 116 may include dimension values, a density, value, time-based values associated with application data, audio data associated with application data, theme color values, sensor values, or other environmental inputs that developers may integrate into graphic code associated with software applications to seamlessly configure visual appearances of graphical assets—without having to manually develop and deploy code for the visual appearances. Dimensional parameters 116 may indicate values that may be input into one or more visual effects expressions (e.g., visual effects expressions 136 included in graphic code 126 associated with a graphical asset of an application of applications 112) to output information associated with rendering parameters 118. Rendering parameters 118 may include values input as parameters of code-based functions associated with presenting one or more visual appearances of a graphical asset. For example, rendering parameters 118 may include values indicating a shape, color, dimension, animation, or other visual effect that computing device 110 may input into graphic commands (e.g., drawing lines, paths, color, fills, three-dimensional commands, scene graphs, etc.) to display dynamic graphical assets.

Display device 106 of computing device 110 may function as an input device for computing device 110 and as an output device for computing device 110. Display device 106 may be implemented using various technologies. For instance, display device 106 may function as an input device using a presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence sensitive display technology. Display device 106 may function as an output (e.g., display) device using any one or more devices, such as a liquid crystal display (LCD), dot matrix display, light emitting diode (LED) display, microLED, miniLED, organic light emitting diode (OLED) display, e-ink, or similar monochrome or color display capable of outputting visible information to a user of computing device 110.

Display device 106 of computing device 110 may include a presence-sensitive display that may receive tactile input from a user of computing device 110. Display device 106 may receive indications of tactile input by detecting one or more gestures from a user of computing device 110 (e.g., the user touching or pointing to one or more locations of display device 106 with a finger or a stylus pen). Display device 106 may present output to a user, for instance at a presence-sensitive display. Display device 106 may present the output as a graphical user interface (e.g., created by executing graphic code associated with one or more applications 112), which may be associated with functionality provided by computing device 110 executing applications 112. For example, display device 106 may present various user interfaces of components of a computing platform, operating system, applications, or services executing at or accessible by computing device 110 (e.g., a music or video streaming application, a social media application, a gaming application, an electronic messaging application, a mobile operating system, etc.). A user may interact with a respective user interface to cause computing device 110 to perform operations relating to a function (e.g., update a graphical user interface associated with applications 112 based on rendering parameters 118 determined based on dimensional parameters 116).

Computing device 110 may execute applications 112 and UI module 114 with one or more processors. A user of computing device 110 may provide user input to execute applications 112. The user input may include a touch input, a voice input, a keyboard input, a mouse, trackpad, or other pointing device input, etc. The user input may be a selection of an application icon, a link, or other graphical or textual object that is associated with particular functionality of application 112 (e.g., a default or “home” screen of the application, navigation instruction functionality, mapping functionality, restaurant listing functionality, nearby store functionality, telephony functionality, social network functionality, gaming functionality, or any other functionality provided by the application).

Applications 112 may include software applications developed using application developer system 120 and/or computing system 130. Application developer system 120 and computing system 130 may be included in an integrated development environment. An integrated development environment may include a collection of hardware and software components, distributed throughout application developer system 120 and computing system 130, that provide software developers one or more platforms, interfaces, and/or tools to develop applications 112, such as code editors, compilers, interpreters, debuggers, build automation, or the like. In some examples, application developer system 120 may be internal to computing system 130, or vice versa.

Application developer system 120 may be associated with a developer of one or more software applications of applications 112. In other words, application developer system 120 may be operated by software developers developing software applications, such as any of applications 112. Application developer system 120 represents any suitable computing system, such as one or more desktop computers, laptop computers, mainframes, servers, cloud computing systems, etc. capable of sending information to and receiving information from computing system 130 via a network, such as network 140. Application developer system 120 hosts (or at least provides access to) information associated with one or more applications executable by computing device 110. In some examples, application developer system 120 represents a cloud computing system that provides the applications via the cloud.

Application developer system 120 represents a mobile or non-mobile computing device. Examples of application developer system 120 include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof configured to send and receive information via a network, such as network 140.

Application developer system 120, in the example of FIG. 1, may include graphical asset application programming interface (API) 122, user interface (UI) coding platform 124, and graphic code 126. UI coding platform 124 may include a terminal or interface that a developer associated with application developer system 120 may create, modify, debug, deploy, or otherwise manage graphic code 126. Graphic code 126 may include computer readable instructions that define a rendering of graphical assets (e.g., an image of a logo, a button, a timer indicator, etc.). Graphic code 126 may include software code that specifies points, lines, curves, shapes, animations, or other visual effects of graphical assets that may be included in applications deployed using application developer system 120. Application developer system 120, according to the techniques described herein, may deploy graphic code 126 to include visual effects expressions 136 that application developer system 120 may obtain from computing system 130 using graphical asset API 122.

Application developer system 120 may use graphical asset API 122 to communicate data to and from computing system 130. Computing system 130 may include a collection of hardware and software components that support software development operations associated with applications 112. For example, computing system 130 may represent cloud-based servers that host code development tools that developers operating application developer system 120 may use when creating, updating, deploying, or otherwise managing applications 112. In the example of FIG. 1, computing system 130 may include visual effects expression module 132, expression configuration information 134, and visual effects expressions 136. Visual effects expression module 132 may include computer readable instructions for software tools developers may use to create, modify, integrate, or otherwise manage expression configuration information 134 and visual effects expressions 136. Expression configuration information 134 may represent data indicating instructions for implementing visual effects expressions 136 when presenting graphical assets. For example, expression configuration information 134 may include instructions for determining dimensional parameters to input into one or more visual effects expressions 136 when displaying a visual appearance for a graphical asset. Visual effects expressions 136 may include mathematical expressions that input dimensional parameters and output information associated with visual effects for graphical assets. Visual effects for graphical assets may indicate graphical behaviors of the graphical asset, such as a shape of the graphical asset, a color of the graphical asset, an animation of the graphical asset, or other design feature of the graphical asset. Computing system 130 may use visual effects expression module 132 to create and deploy expression configuration information 134 and visual effects expressions 136 to application developers to include in graphical assets presented as part of software application. In the example of FIG. 1, application developer system 120 may use UI coding platform 124 and graphical asset API 122 to create graphic code 126 for a graphical asset to include visual effects expressions 136.

Integrated development environments may provide software application developers software development tools for creating computer executable code that integrates motion and other interactions in user interfaces as graphical assets. For example, application developers may operate computing devices of an application development system to manually type, test, and deploy software code for each variation of visual appearance a graphical asset may have, such as a ripple of an icon, a change of shape of a button, an animation of an image, or the like.

User interface development tools may support development and integration of graphical assets in user interfaces by separating a presentation layer associated with what is being presented in graphical assets and a function layer associated with interactive complexities that a graphical asset may be coded to have (e.g., animations, shape morphing, motion, playful interactions, etc.). However, such user interface development tools separating the presentation layer and the function layer may-despite expanded visual appearance capabilities-result in more code having to be written, maintained, and deployed; thereby making difficult for user interface code to be written, maintained, and reused, especially at scale. In other words, such user interface development tools may be presented with technical problems such as (a) code complexity associated with updating, deploying or otherwise creating dynamic graphical assets, (b) performance of computing devices executing code associated with graphical assets, (c) power consumption associated with computing devices retrieving or otherwise executing code associated with graphical assets, and/or (d) flexibility in improving user experiences, such as user interfaces providing user experiences via expression-based graphic commands. Computing system 130, according to the techniques described herein, may improve software development for dynamic graphical assets by providing visual effects expressions 136 to application developer system 120. Application developer system 120 may integrate visual effects expressions 136 in graphic code 126 for graphic assets associated with applications 112 to separate software code development associated with a functional layer of an application and software code development associated with a presentation layer of the application. Application developer system 120 may dynamically deploy sets of rendering parameters 118 for visual effects expressions 136 included in code for applications 112 such that developers may generate, use, modify, reuse, or otherwise implement complex behaviors across graphical assets associated with applications 112. In this way, by application developer system 120 implementing visual effects expressions 136 in code for applications 112, computing device 110 may efficiently execute applications 112 to dynamically display various versions of graphical assets that may be determined at real-time (e.g., during executing of applications 112 in a way that does not require recompilation of code, retrieval of code updates, or other performance or power drawbacks associated with hard-coding visual effects of graphic code).

In accordance with the techniques described herein, application developer system 120 may integrate visual effects expressions 136 in graphic code 126 for dynamic, real-time graphical asset generation at computing device 110. Application developer system 120 may integrate visual effects expressions 136, obtained from computing system 130, in software application code files (e.g., graphic code 126 including software code associated with graphical assets of one or more of applications 112) such that user devices executing the software application code files may generate and output dynamic graphical behaviors for graphical assets of user interfaces associated with one or more of applications 112. For instance, computing device 110 may dynamically generate—based on dimensional parameters 116 and visual effects expressions 136 included in graphic code 126 for software application code of one or more applications 112—rendering parameters 118 that indicate visual effects of graphical assets associated with one or more of applications 112. In this way, integrated developer environments may implement visual effects expressions 136 in software application code to enhance an application developer's ability to dynamically include complex visual effects at scale and/or improve a user device performance associated with executing code for displaying dynamic graphical assets of user interfaces.

In operation, computing device 110, or more specifically UI module 114, may obtain dimensional parameters 116 for a graphical asset of a user interface for one or more applications 112. Dimensional parameters 116 may indicate one or more values for a visual effects expression of visual effects expressions 136 that is configured to output information associated with visual effects for a graphical asset. For example, dimensional parameters 116 may indicate dimension values, density values, time-based value, application-specific values, motion values, sensor values, or other external values that may be dynamically input into visual effects expressions 136 for determining visual appearances of graphical assets. In some examples, computing device 110 may obtain dimensional parameters 116 from application developer system 120, via network 140 for example. For example, computing device 110 may obtain dimensional parameters 116 as part of an update for a graphical asset associated with a software application of applications 112.

In some instances, computing device 110 may obtain dimensional parameters 116 based on a determination using application, environmental, sensor, or other external signals. For instance, computing device 110 may obtain dimensional parameters 116 based on determining a time value and an amplitude value associated with audio data output during execution of the application. During execution of the application, UI module 114 may input dimensional parameters 116 into visual effects expressions of graphic code associated with the application to display a user interface configured with a graphical asset (e.g., time indicator) that includes visual effects (e.g., a ripple effect) that is particular to rendering parameters determined using the obtained dimensional parameters 116.

UI module 114 may generate rendering parameters 118 for graphic code associated with one or more applications 112. For example, UI module 114 may generate rendering parameters 118 by at least providing a set of dimensional parameters 116 as inputs to a visual effects expression included in graphic code for a graphical asset of a user interface associated with one or more applications 112. In other words, UI module 114 may, during real-time execution of applications 112, generate rendering parameters 118 indicating one or more visual effects (e.g., ripple, color change, shape change, animation, theme, etc.) for a graphical asset associated with applications 112. UI module 114 may store generated rendering parameters as cached data. In this way, UI module 114 may efficiently retrieve cached rendering parameters in instances where similar or same dimensional parameters are obtained when displaying a graphical asset according to the techniques described herein. By automatically caching rendering parameters as particular versions of visual appearances (e.g., vector display drawings, three-dimensional commands, scene graphs, shaders, etc.) for a graphical asset, developers may continuously and seamlessly update graphical assets to be a target-specific asset according to an analysis of the cached data. In this way, developers may efficiently create software applications executed by computing device 110 to efficiently reuse previously computed visual appearances when the same dimensional parameters are determined or otherwise encountered.

In some examples, UI module 114 may generate rendering parameters 118 based on inputting one or more outside inputs into a visual effects expression. For instance, UI module 114 may access expression configuration information 134 associated with a visual effects expression of visual effects expressions 136 implemented in a graphical asset to be displayed during execution of applications 112. UI module 114 may generate, based on outside inputs (e.g., time values, sensor inputs, application data, environmental data, theme, etc.) mapped to dimensional parameters 116 in expression configuration information 134, rendering parameters 118. UI module 114 may store rendering parameters 118 as cached data to efficiently generate and output a user interface configured to display the graphical asset according to rendering parameters mapped to dimensional parameters 116 (e.g., in expression configuration information 134).

UI module 114 may generate a user interface based on rendering parameters 118. For instance, during execution of applications 112, UI module 114 may generate data for a user interface by inputting rendering parameters 118 into graphic command code instructions for displaying a graphical asset associated with applications 112 as part of execution of applications 112. UI module 114 may output, for display via display device 106, a user interface configured with a visual appearance of a graphical asset indicated by one or more rendering parameters 118. For example, UI module 114 may output a user interface configured with a visual appearance of a graphical asset (e.g., a button, a logo, a time indicator, etc.) associated with drawings, animations, or other visual effects indicated by a compilation of rendering parameters 118.

The techniques may provide one or more technical advantages that realize a practical application. For example, integrated developer environments (e.g., application developer system 120 and/or computing system 130) may implement visual effects expressions into graphic code as a single code file to create a lightweight, easily configurable data structure for graphical assets. Integrated developer environments may implement a mathematical expression engine and animation module based on an efficient interpreter for encoded expressions (e.g., a Reverse Polish Notation (RPN) interpreter) to support a variety of graphic outputs (e.g., vector graphic) that may be output using visual effects expressions. In other words, visual effects expressions provide an efficient implementation of graphical assets with visual appearances that may be dynamically determined during real-time execution of software applications.

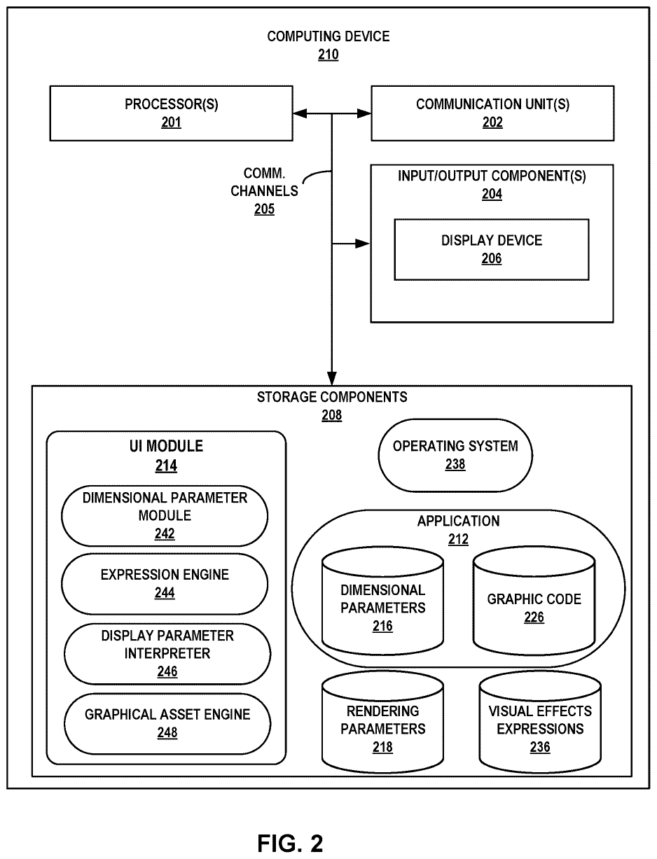

FIG. 2 is a block diagram illustrating example computing device 210 configured to execute example graphic code 226 including example rendering parameters 218 created using example visual effects expressions 236, in accordance with one or more aspects of the present disclosure. Computing device 210, display device 206, UI module 214, application 212, dimensional parameters 216, rendering parameters 218, and visual effects expressions 236 of FIG. 2 may be example or alternative implementations of computing device 110, display device 106, UI module 114, one or more applications 112, dimensional parameters 116, rendering parameters 118, and visual effects expressions 136 of FIG. 1, respectively.

As illustrated in the example of FIG. 2, computing device 210 may include one or more processors 201, one or more communication units 202, one or more input/output components 204 (“I/O components 204”), storage components 208, and communication channels 205. Communication channels 205 may interconnect each of the components 201, 202, 204, and 208 for inter-component communications (physically, communicatively, and/or operatively). In some examples, communication channels 205 may include a system bus, a network connection, an inter-process communication data structure, or any other method for communicating data.

One or more I/O components 204 of computing device 210 may be configured to receive input. Examples of input are tactile, audio, and video input. I/O components 204 may be configured to generate output. Examples of output are tactile, audio, and video output. I/O components 204, in one example, includes a presence-sensitive display, sound card, video graphics adapter card, speaker, liquid crystal display (LCD), inertial measurement units, touch-sensitive screen, mouse, keyboard, voice responsive system, video camera, microphone, or any other type of device for generating output to and/or detecting input from a human or machine

One or more communication units 202 of computing device 210 may be configured to communicate with external devices via one or more wired and/or wireless networks by transmitting and/or receiving network signals on the one or more networks. Examples of communication unit 202 may include a network interface card (e.g. such as an Ethernet card), an optical transceiver, a radio frequency transceiver, a GNSS receiver, GPS receiver, or any other type of device that can send and/or receive information. Other examples of communication units 202 may include short wave radios, cellular data radios, wireless network radios, as well as universal serial bus (USB) controllers.

One or more processors 201 may implement functionality and/or execute instructions within computing device 210. For example, processors 201 on computing device 210 may receive and execute instructions stored by storage components 208 that execute the functionality of UI module 214, application 212, and/or operating system 238. These instructions executed by processors 201 may cause computing device 210 to store and/or modify information within storage components 208 or processors 201 during program execution. Processors 201 may execute instructions of UI module 214, application 212, and/or operating system 238 to perform one or more operations. That is UI module 214, application 212, and/or operating system 238 may be operable by processors 201 to perform various functions described herein. In some examples, UI module 214 may be a component of application 212.

One or more storage components 208 within computing device 210, in the example of FIG. 2, may include UI module 214, application 212, rendering parameters 218, visual effects expressions 236, and/or operating system 238. Storage components 208 may store information for processing during operation of computing device 210 (e.g., computing device 210 may store data accessed by UI module 214, application 212, and/or operating system 238 during execution at computing device 210). In some examples, storage components 208 is a temporary memory, meaning that a primary purpose of storage components 208 is not long-term storage. Storage components 208 on computing device 210 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

Storage components 208, in some examples, also include one or more computer-readable storage media. Storage components 208 may be configured to store larger amounts of information than volatile memory. Storage components 208 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 208 may store program instructions and/or information (e.g., data) associated with UI module 214, application 212, and/or operating system 238.

OS 238 may control the operation of components of computing device 210. For example, OS 238 may facilitate the communication of UI module 214, application 212, and/or operating system 238 with processors 201, storage components 208, I/O components 204, and communication units 202. In some examples, OS 238 may manage interactions between software applications (e.g., application 212) and a user operating computing device 210. OS 238 may have a kernel that facilitates interactions with underlying hardware of computing device 210 and provides a fully formed application space capable of executing a wide variety of software applications having secure partitions in which each of the software applications executes to perform various operations.

In accordance with techniques of this disclosure, UI module 214 may dynamically determine rendering parameters 218 using visual effects expressions 236. For example, during execution of application 212, dimensional parameter module 242 of UI module 214 may obtain a set of dimensional parameters 216 for a graphical asset (e.g., button, logo, indicator, etc.) displayed as part of the execution of application 212. Dimensional parameter module 242 may provide dimensional parameters 216 to expression engine 244. Expression engine 244 may input dimensional parameters 216 into one or more visual effects expressions 236 to output information associated with visual effects for graphical assets.

Expression engine 244 may process mathematical expressions or animation or motion-based expressions using graphic notation or conventions associated with application 212. For example, expression engine 244 may process visual effects expressions 236 using display parameter interpreter 246. Display parameter interpreter 246 may, for example, convert dimensional parameters 216 into a standardized format (e.g., Reverse Polish Notation (RPN)) that may be input into the standardized format of visual effects expressions 236. Display parameter interpreter 246 may process visual effects expressions 236 written in RPN using an RPN interpreter to efficiently compute outputs in a language closer to a processing language. By expression engine 244 processing visual effects expressions 236 written in RPN using the RPN interpreter, graphic code 226 may include visual effects expressions 236 implemented as tight binary encodings. In other words, visual effects expressions 236 implemented as a graphical asset in graphic code 226 may provide flexible graphical effects capability at a size associated with the tight binary encodings, which may be smaller size compared to conventional assets having a size associated with graphical files (e.g., JPG, GIF, PNG, etc.). Display parameter interpreter 246 may support a variety of commands that are allowed in visual effects expressions 236. For example, display parameter interpreter 246 may support commands associated with executing additional code (e.g., JAVASCRIPT files) attached, referenced, or otherwise associated with processing visual effects expressions 236.

Expression engine 244 may provide outputs of visual effects expressions 236 (e.g., information associated with visual effects for graphical assets associated with application 212) to display parameter interpreter 246. Display parameter interpreter 246 may generate rendering parameters 218 using outputs of visual effects expressions 236. For example, display parameter interpreter 246 may determine, based on inputting dimensional parameters 216 into one or more visual effects expressions 236 for a graphical asset, a state associated with execution of application 212. A state associated with execution of application 212 may include conditions, criteria, or other data structure that may be used to classify a set of input dimensional parameters. For instance, a state associated with execution of application 212 may include time-based values, application specific parameters (e.g., parameters associated audio data, video data, or other data associated with application 212), graphical dimensions associated with input dimensional parameters, density or color values associated with input dimensional parameters, or the like. Display parameter interpreter 246 may, for example, determine a state based on an output of a visual effects expression satisfying one or more conditions or criteria associated with the state.

Display parameter interpreter 246 may generate, based on the state being mapped to one or more visual effects in configuration data associated with application 212 (e.g., configuration data associated with graphic code 226, expression configuration information 134 of FIG. 1, etc.), rendering parameters 218 indicating one or more visual effects for the graphical asset. For example, graphic code 226 may include configuration information that maps a state-indicating that audio data is being output during execution of application 212 at a certain time-to a visual effect (e.g., a ripple effect with a frequency that corresponds to the audio data at the certain time). Display parameters interpreter 246 may store generated rendering parameters 218 as cached data for efficiency and performance benefits associated with instances where input conditions do not change.

Graphical asset engine 248 may input rendering parameters 218 into graphic code 226. Graphical asset engine 248 may, based on an indication to display a graphical asset associated with graphic code 226, generate a user interface that configured a visual appearance (e.g., a rendering of graphic code 226 that has a vector drawing with a color morphing effect corresponding to a state determined using a visual effect expression) of the graphical asset according to rendering parameters 218 mapped to dimensional parameters 216 (e.g., in configuration data associated with graphic code 226). UI module 214 may output the user interface, for display via display device 206, to include the graphical asset having the visual appearance associated with visual effects indicated by rendering parameters 218.

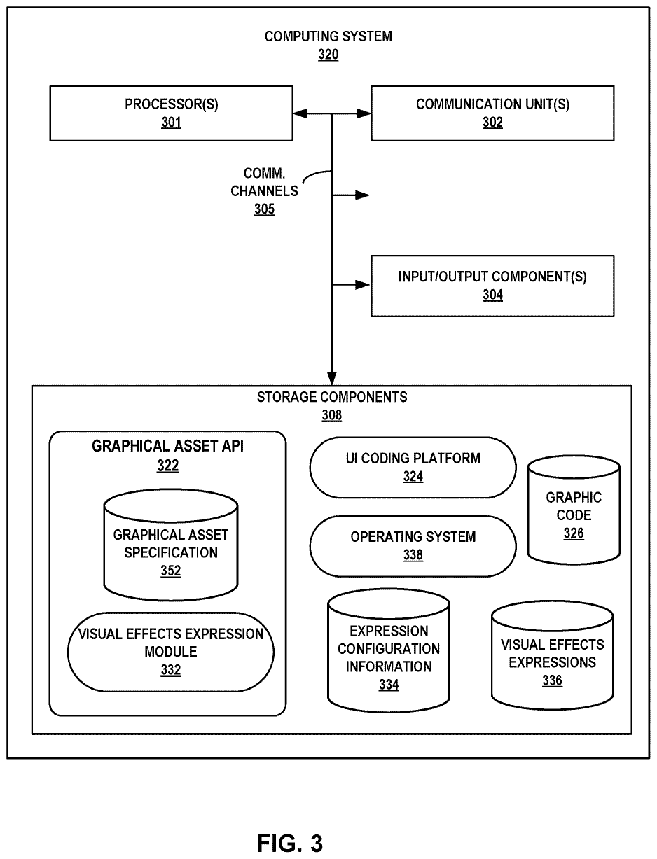

FIG. 3 is a block diagram illustrating example computing system 320 for implementing example visual effects expressions 336 in example graphic code 326 for one or more graphical assets, in accordance with one or more aspects of the present disclosure. Computing system 320 of FIG. 3 may be an example or alternative implementation of application developer system 120 and/or computing system 130 of FIG. 1. Graphical asset API 322, UI coding platform 324, graphic code 326, expression configuration information 334, and visual effects expressions 336 of FIG. 3 may be example or alternative implementations of graphical asset API 122, UI coding platform 124, graphic code 126, expression configuration information 134, and visual effects expressions 136 of FIG. 1, respectively.

As illustrated in the example of FIG. 3, computing system 320 may include one or more processors 301, one or more communication units 302, one or more input/output components 304 (“I/O components 304”), storage components 308, and communication channels 305. Communication channels 305 may interconnect each of the components 301, 302, 304, and 308 for inter-component communications (physically, communicatively, and/or operatively). In some examples, communication channels 305 may include a system bus, a network connection, an inter-process communication data structure, or any other method for communicating data.

One or more I/O components 304 of computing system 320 may be configured to receive input. Examples of input are tactile, audio, and video input. I/O components 304 may be configured to generate output. Examples of output are tactile, audio, and video output. I/O components 304, in one example, includes a presence-sensitive display, sound card, video graphics adapter card, speaker, liquid crystal display (LCD), inertial measurement units, touch-sensitive screen, mouse, keyboard, voice responsive system, video camera, microphone, or any other type of device for generating output to and/or detecting input from a human or machine

One or more communication units 302 of computing system 320 may be configured to communicate with external devices via one or more wired and/or wireless networks by transmitting and/or receiving network signals on the one or more networks. Examples of communication unit 302 may include a network interface card (e.g. such as an Ethernet card), an optical transceiver, a radio frequency transceiver, a GNSS receiver, GPS receiver, or any other type of device that can send and/or receive information. Other examples of communication units 302 may include short wave radios, cellular data radios, wireless network radios, as well as universal serial bus (USB) controllers.

One or more processors 301 may implement functionality and/or execute instructions within computing system 320. For example, processors 301 on computing system 320 may receive and execute instructions stored by storage components 208 that execute the functionality of graphical asset API 322, UI coding platform 324, and/or operating system 338. These instructions executed by processors 301 may cause computing system 320 to store and/or modify information within storage components 308 or processors 301 during program execution. Processors 301 may execute instructions of graphical asset API 322, UI coding platform 324, and/or operating system 338 to perform one or more operations. That is graphical asset API 322, UI coding platform 324, and/or operating system 338 may be operable by processors 301 to perform various functions described herein.

One or more storage components 308 within computing system 320, in the example of FIG. 3, may include graphical asset API 322, UI coding platform 324, graphic code 326, expression configuration information 334, visual effects expressions 336, and/or operating system 338. Storage components 308 may store information for processing during operation of computing system 320 (e.g., computing system 320 may store data accessed by graphical asset API 322, UI coding platform 324, and/or operating system 338 during execution at computing system 320). In some examples, storage components 308 is a temporary memory, meaning that a primary purpose of storage components 308 is not long-term storage. Storage components 308 on computing system 320 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

Storage components 308, in some examples, also include one or more computer-readable storage media. Storage components 308 may be configured to store larger amounts of information than volatile memory. Storage components 308 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 308 may store program instructions and/or information (e.g., data) associated with graphical asset API 322, UI coding platform 324, and/or operating system 338.

OS 338 may control the operation of components of computing system 320. For example, OS 338 may facilitate the communication of graphical asset API 322, UI coding platform 324, and/or operating system 338 with processors 301, storage components 308, I/O components 304, and communication units 302. OS 338 may have a kernel that facilitates interactions with underlying hardware of computing system 320 and provides a fully formed application space capable of executing a wide variety of software applications having secure partitions in which each of the software applications executes to perform various operations.

In accordance with techniques of this disclosure, computing system 320 may develop graphic code 326 for graphical assets to include visual effects expressions 336. Computing system 230 may use graphical asset API 322 to define graphical asset specification 352. Graphical asset specification 352 may include graphic, motion, animation, or other design details associated with a graphical asset, such as details of visual effects for visual appearances of a button or indicator responsive to particular external inputs (e.g., dimensional parameters 116 of FIG. 1). Computing system 320 may use UI coding platform 324 and visual effects expression module 332 of graphical asset API 322 to generate graphic code 326 for a graphical asset as a single code file that includes one or more visual effects expressions 336 based on design details of graphical asset specification 352. Visual effects expression module 332 may convert mathematical expressions associated with visual effects expressions into RPN to efficiently deploy graphic code 326. For example, responsive to receiving a regular mathematical expression (e.g., describing functions or other equations defining a shape, motion, animation, color, etc. of a graphical asset) as part of graphical asset specification 352, visual effects expression module 332 may convert the regular mathematical expression into RPN and store the RPN translation for the expression as visual effects expressions 336. In this way, when visual effects expressions 336 are implemented into graphic code 326, user devices may efficiently process visual effects expressions 336, written in RPN, using an RPN interpreter.

Typically, graphic code may include hard-coded rendering parameters that would need to be recoded, reconfigured, and redeployed in response to any changes. Conventional code for a static graphical asset of a button may be as follows:
internal class MyButton(context: Context): View(context) {
override fun onDraw(canvas: Canvas) {
   val path =Path()
   val paint =Paint()
   path.addRoundRect(0f, 0f, width.toFloat( ), height.toFloat( ),
      20f, 20f, Path.Direction.CW)
   path.close( )
   paint.color=Color(200, 200, 200).toArgb( )
   canvas.drawPath(path, paint)
   }
      where rendering parameters, such as color values, dimension values, etc., need to be redeployed and recompiled in response to any changes in design specifications of a graphical asset.

Computing system 320, according to the techniques described herein, may implement a visual effect expression of visual effects expressions 336 into graphic code 326 such that computing devices executing graphic code 326 (e.g., during execution of an application deployed using computing system 320) may dynamically generate and output visual appearances without developers manually coding the visual appearances. For instance, computing system 320 may generate graphic code 326 for a button graphical asset to include the following code:
internal class MyButton(context: Context): View(context) {
val myDecorator=MyDecorator(“path/to/VISUAL EFFECT EXPRESSION”)
override fun onDraw(canvas: Canvas) {
myDecorator.paint(width, height)}},
   where “path/to/VISUAL EFFECT EXPRESSION” may include an address or pointer to an encoding (e.g., binary encoding in RPN) representing a visual effect expression. An example of visual effects expressions written in JAVA may be as follows: public static RemotePath circle(DocWriter rc, float x, float y, float rad) {
float C=0.5522847498f;
float c=rc.floatExpression(rad, C,MUL);
RemotePath path=new RemotePath( );
float xc=rc.floatExpression(x, c,ADD);
float yc=rc.floatExpression(y, c,ADD);
float xr=rc.floatExpression(x, rad,ADD);
float yr=rc.floatExpression(y, rad,ADD);
float x_c=rc.floatExpression(x, c,SUB);
float y_c=rc.floatExpression(y, c,SUB);
float x_r=rc.floatExpression(x, rad,SUB);
float y_r=rc.floatExpression(y, rad,SUB);
path.moveTo(xr, y);
path.cubicTo(xr, yc, xc, yr, x, yr);
path.cubicTo(x_c, yr, x_r, yc, x_r, y);
path.cubicTo(x_r, y_c, x_c, y_r, x, y_r);
path.cubicTo(xc, y_r, xr, y_c, xr, y);
path.close( );
return path; }

In this way, when a computing device executes graphic code 326, the computing device may determine, on the fly, rendering parameters for a design of “MyDecorator” based on outputs of a visual effect expression.

In some examples, graphic code 326 may include multiple visual effect expressions indicating one or more graphical assets that may be arranged by developers or designers. For instance, graphic code 326 may include a first visual effect expression for a first graphical asset, a second visual effect expression for a third graphical asset, and so on. Each of the visual effect expressions for respective graphical assets may be capable of numerous graphical effects associated with a complexity of the visual effect expressions. For example, visual effect expressions may be simple in terms of drawing a shape based on a set of input dimensional parameters. Visual effect expressions may be complex in terms of motion or changes in color that may be determined, on the fly, based on inputting dimensional parameters into the visual effect expressions. In general, visual effect expressions provide developers an opportunity to dynamically define graphical assets without manually creating and deploying code for updates, various versions, or other management tasks.

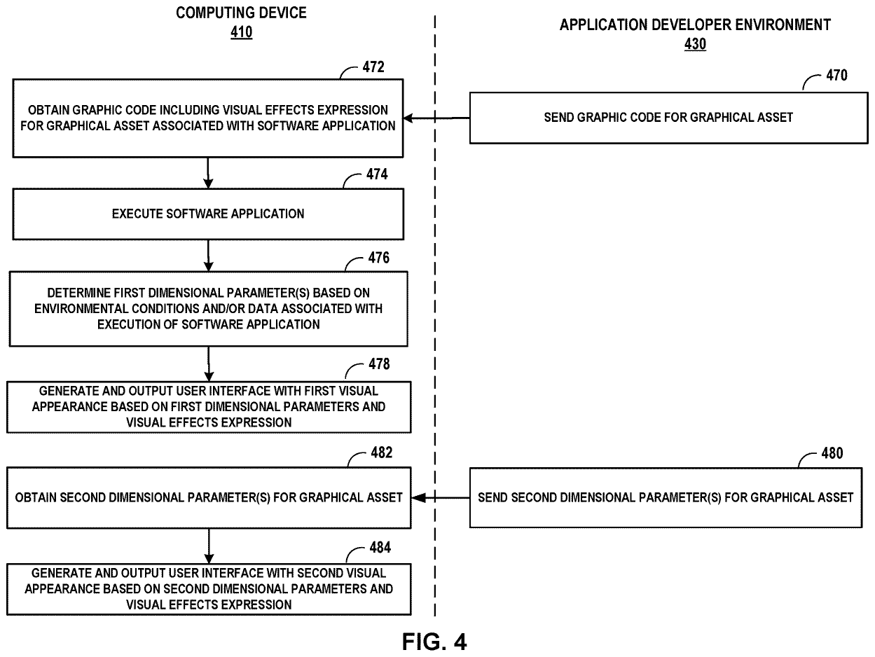

FIG. 4 is a flowchart illustrating an example operation of a computing environment configured to implement graphic code including visual effects expressions, in accordance with one or more aspects of the present disclosure. Computing device 410 in the example of FIG. 4 may be an example or alternative implementation of computing device 210 of FIG. 2. Application developer environment 430 of FIG. 4 may be an example or alternative implementation of computing system 320 of FIG. 3.

In the example of FIG. 4, application developer environment 430 may send computing device 410 graphic code for a graphical asset (470). Computing device 410 may obtain, from application developer environment 430, the graphic code including visual effects expressions for the graphical asset associated with a software application (472). Computing device 410 may execute the software application (474). Computing device 410 may determine a first set of dimensional parameters based on environmental conditions and/or data associated with execution of the software application (476). Computing device 410 may generate and output a user interface with a first set of visual appearances based on the first set of dimensional parameters and the visual effects expressions included in the graphic code (478).

In some examples, application developer environment 430 may send computing device 410 a second set of dimensional parameters for the graphical asset (480). Computing device 410 may obtain the second set of dimensional parameters for the graphical asset (482). Computing device 410 may generate and output an updated user interface for the software application with a second set of visual appearances based on the second set of dimensional parameters and the visual effects expressions included in the graphic code (484).

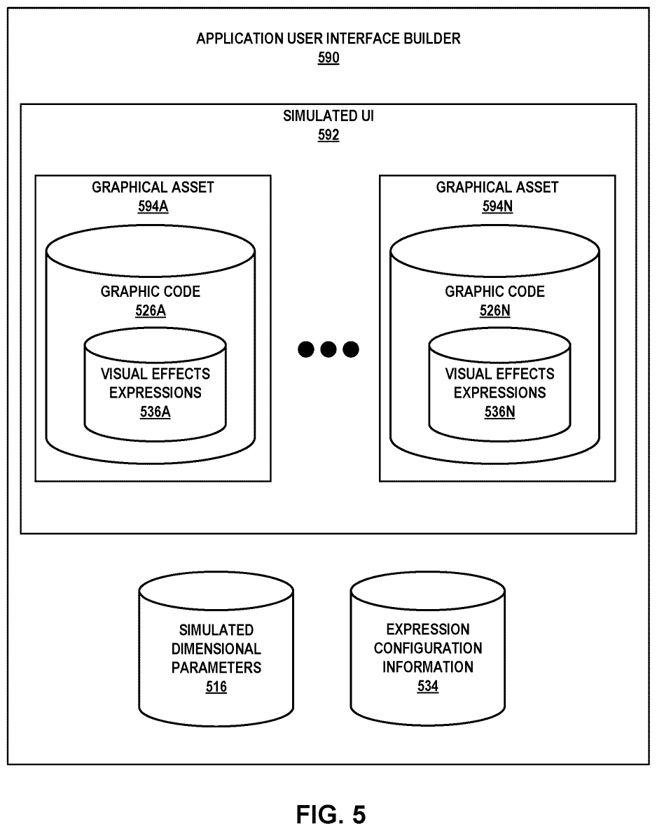

FIG. 5 is a block diagram illustrating example application user interface builder 590, in accordance with one or more aspects of the present disclosure. Application user interface builder 590 may represent a software development tool for designing a user interface for a software application (e.g., applications 112 of FIG. 1). Computing system 130 of FIG. 1 may, for example, offer functionality associated with application user interface builder 590 to application developer system 120 as part of graphical asset API 122. Graphic code 526A-526N (collectively referred to as “graphic code 526”), visual effects expressions 536A-536N (collectively referred to as “visual effects expressions 536”), simulate dimensional parameters 516, and expression configuration information 534 of FIG. 5 may be example or alternative implementations of graphic code 126, dimensional parameters 116, and expression configuration information 134 of FIG. 1, respectively.

In the example of FIG. 5, application user interface builder 590 may include simulated user interface (UI) 592. Simulated UI 592 may be a module configured to simulate a user device environment, such as a mobile environment, a personal wearable device environment, an automobile interface environment, or the like. Simulated UI 592 may be a component of UI coding platform 124 of FIG. 1, for example. Developers may interact with application user interface builder 590 to position one or more of graphical assets 594A-594N throughout simulated UI 592. For instance, a developer may position graphical asset 594A on a middle left of simulated UI 592, and position graphical asset 594N on a middle right of simulated UI 592. Developers may update or change expression configuration information 534 to define, specify, alter, or otherwise manage complexities and implementations of visual effect expressions 536, such as manage state mappings to visual effects, deployment dimension updates, or the like. For example, developers may attach additional code files as part of expression configuration information 534 to make implementations of visual effect expressions more complex.

Graphical asset 594A includes graphic code 526A with a first set of visual effect expressions 536A. For instance, graphical asset 594A may include graphic code 526A with a first set of visual effect expressions 536A that defines a dynamic vector animation generated, during real time execution of an application associated with simulated UI 592, based on simulated dimensional parameters 516. Graphical asset 594N includes graphic code 526N with a second set of visual effect expressions 536N. For instance, graphical asset 594N may include a logo that is configured to have a visual appearance with a visual effect based on inputting simulated dimensional parameters 516 into visual effect expressions 536N. Developers may combine a combination of one or more graphical assets 594 to create a single code file that may be deployed as part of a software application.

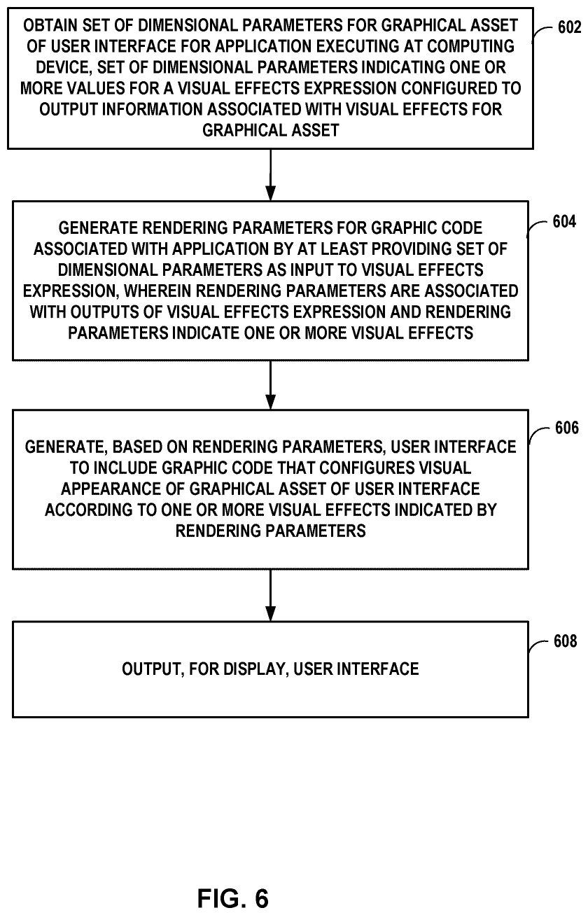

FIG. 6 is a flowchart illustrating an example operation for a computing device configured to create user interfaces using visual effects expressions, in accordance with one or more aspects of the present disclosure. FIG. 6 may be discussed with respect to FIG. 1 for example purposes only.

Computing device 110 may obtain a set of dimensional parameters for a graphical asset of a user interface for an application executing at computing device 110, the set of dimensional parameters indicating one or more values for a visual effects expression configured to output information associated with visual effects for the graphical asset (602). Computing device 110 may generate rendering parameters for graphic code associated with the application by at least providing the set of dimensional parameters as inputs to the visual effects expression, wherein the rendering parameters are associated with outputs of the visual effects expression and the rendering parameters indicate one or more visual effects (604). For example, computing device 110 may provide a time variable and application data as inputs to a visual effects expression associated with a graphical asset of a digital watch face. Computing device 110 may generate rendering parameters for graphic code defining a visual effect of a motion of the digital watch face that is particular to the time variable and the application data (e.g., a watch face with a motion of ticking in a way associated with a personal wearable device or mobile application). Computing device 110 may generate, based on the rendering parameters, a user interface to include the graphic code that configures a visual appearance of the graphical asset of the user interface according to the one or more visual effects indicated by the rendering parameters (606). For example, computing device 110 may generate a user interface for an application to include a graphical asset that is drawn —during real time execution of the application —using the generated rendering parameters (e.g., a graphical asset of a watch face that is drawn with a motion of ticking according to a state determined for the application based on the set of dimensional parameters). Computing device 110 may output, for display, the user interface (608).

Example 1: A method includes obtaining, by a computing device, a set of dimensional parameters for a graphical asset of a user interface for an application executing at the computing device, the set of dimensional parameters indicating one or more values for a visual effects expression, the visual effects expression configured to output information associated with visual effects for the graphical asset; generating, by the computing device, rendering parameters for graphic code associated with the application by at least providing the set of dimensional parameters as input to the visual effects expression, wherein the rendering parameters are associated with outputs of the visual effects expression and the rendering parameters indicate one or more visual effects; generating, by the computing device and based on the rendering parameters, the user interface to include the graphic code that configures a visual appearance of the graphical asset of the user interface according to the one or more visual effects indicated by the rendering parameters; and outputting, by the computing device and for display, the user interface.

Example 2: The method of example 1, wherein the set of dimensional parameters include one or more of: one or more dimension values associated with the graphical asset, a density value associated with the graphical asset, time-based values associated with the application, or audio data associated with the application.

Example 3: The method of any of examples 1 and 2, wherein obtaining the set of dimensional parameters comprises obtaining the set of dimensional parameters from a development environment associated with the application.

Example 4: The method of any of examples 1 through 3, wherein obtaining the set of dimensional parameters comprises determining a time value and an amplitude value associated audio data output during execution of the application, and wherein the one or more visual effects include a ripple effect for a time indicator of the graphical asset.

Example 5: The method of any of examples 1 through 4, wherein generating the set of rendering parameters comprises: determining, based on inputting the set of dimensional parameters into the visual effects expression, a state associated with the execution of the application; generating, based on the state being mapped to the one or more visual effects in configuration data associated with the application, the set of rendering parameters indicating the one or more visual effects; and inputting the rendering parameters in the graphic code.

Example 6: The method of any of examples 1 through 5, wherein generating the set of rendering parameters further comprises inputting one or more outside inputs into the visual effects expression based on the one or more outside inputs being mapped to the set of dimensional parameters, wherein the one or more outside inputs indicate values associated with one or more of: time, theme color, or a sensor of the computing device.

Example 7: The method of any of examples 1 through 6, wherein the set of dimensional parameters is a first set of dimensional parameters, and wherein the method further comprises: in response to generating the rendering parameters, storing the rendering parameters as cached data; determining a second set of dimensional parameters; and in response to determining the second set of dimensional parameters correspond to the first set of dimensional parameters, accessing the cached data to generate the user interface.

Example 8: The method of any of examples 1 through 7, wherein the set of dimensional parameters is a first set of dimensional parameters, the rendering parameters are a first set of rendering parameters, the one or more visual effects are a first set of visual effects, and the visual appearance is a first visual appearance, and wherein the method further comprises: obtaining a second set of dimensional parameters; generating, based on inputting the second set of dimensional parameters into the visual effects expression, a second set of rendering parameters for the graphic code, the second set of rendering parameters indicating a second set of visual effects; and generating, based on the second set of rendering parameters, the user interface to include the graphic code that configures a second visual appearance of the graphical asset of the user interface according to the second set of visual effects indicated by the second set of rendering parameters.

Example 9: The method of any of examples 1 through 8, further comprising generating, by a developer device, the graphic code as a single code file including the visual effects expression.

Example 10: The method of any of examples 1 through 9, wherein the one or more visual effects indicate graphical behaviors of the graphical asset including one or more of: a shape of the graphical asset, a color of the graphical asset, or an animation of the graphical asset.

Example 11: The method of any of examples 1 through 10, further comprising obtaining the graphic code from an application server hosting the application.

Example 12: The method of any of examples 1 through 11, wherein the visual effects expression is encoded in Reverse Polish Notation (RPN), and wherein generating the rendering parameters comprises interpreting the RPN encoding of the visual effects expression using an RPN interpreter.

Example 13: A device includes a memory; and one or more processors operably coupled to the memory, wherein the one or more processors execute instructions stored at the memory to: obtain a set of dimensional parameters for a graphical asset of a user interface for an application executing at the computing device, the set of dimensional parameters indicating one or more values for a visual effects expression, the visual effects expression configured to output information associated with visual effects for the graphical asset; generate rendering parameters for graphic code associated with the application by at least providing the set of dimensional parameters as input to the visual effects expression, wherein the rendering parameters are associated with outputs of the visual effects expression and the rendering parameters indicate one or more visual effects; generate, based on the rendering parameters, the user interface to include the graphic code that configures a visual appearance of the graphical asset of the user interface according to the one or more visual effects indicated by the rendering parameters; and output, for display, the user interface.

Example 14: The device of example 13, wherein the set of dimensional parameters include one or more of: one or more dimension values associated with the graphical asset, a density value associated with the graphical asset, time-based values associated with the application, or audio data associated with the application.

Example 15: The device of any of examples 13 and 14, wherein to obtain the set of dimensional parameters, the one or more processors execute instructions stored at the memory to obtain the set of dimensional parameters comprises obtaining the set of dimensional parameters from a development environment associated with the application.

Example 16: The device of any of examples 13 through 15, wherein to obtain the set of dimensional parameters, the one or more processors execute instructions stored at the memory to determine a time value and an amplitude value associated audio data output during execution of the application, and wherein the one or more visual effects include a ripple effect for a time indicator of the graphical asset.

Example 17: The device of any of examples 13 through 16, wherein to generate the set of rendering parameters, the one or more processors execute instructions stored at the memory to: determine, based on inputting the set of dimensional parameters into the visual effects expression, a state associated with the execution of the application; generate, based on the state being mapped to the one or more visual effects in configuration data associated with the application, the set of rendering parameters indicating the one or more visual effects; and input the rendering parameters in the graphic code.

Example 18: The device of any of examples 13 through 17, wherein to generate the set of rendering parameters, the one or more processors execute instructions stored at the memory to: input one or more outside inputs into the visual effects expression based on the one or more outside inputs being mapped to the set of dimensional parameters, wherein the one or more outside inputs indicate values associated with one or more of: time, theme color, or a sensor of the computing device.

Example 19: The device of any of examples 13 through 18, wherein the set of dimensional parameters is a first set of dimensional parameters, and wherein the one or more processors further execute instructions stored at the memory to: in response to generating the rendering parameters, store the rendering parameters as cached data; determine a second set of dimensional parameters; and in response to determining the second set of dimensional parameters correspond to the first set of dimensional parameters, access the cached data to generate the user interface.

Example 20: The device of any of examples 13 through 19, wherein the set of dimensional parameters is a first set of dimensional parameters, the rendering parameters are a first set of rendering parameters, the one or more visual effects are a first set of visual effects, and the visual appearance is a first visual appearance, and wherein the one or more processors further execute instructions stored at the memory to: obtain a second set of dimensional parameters; generate, based on inputting the second set of dimensional parameters into the visual effects expression, a second set of rendering parameters for the graphic code, the second set of rendering parameters indicating a second set of visual effects; and generate, based on the second set of rendering parameters, the user interface to include the graphic code that configures a second visual appearance of the graphical asset of the user interface according to the second set of visual effects indicated by the second set of rendering parameters.

Example 21: The device of any of examples 13 through 20, wherein the one or more visual effects indicate graphical behaviors of the graphical asset including one or more of: a shape of the graphical asset, a color of the graphical asset, or an animation of the graphical asset.

Example 22: The device of any of examples 13 through 21, wherein the one or more processors further execute instructions stored at the memory to obtain the graphic code from an application server hosting the application.

Example 23: The device of any of examples 13 through 22, wherein the visual effects expression is encoded in Reverse Polish Notation (RPN), and wherein the instructions that cause the one or more processors to generate the rendering parameters comprise instructions that cause the one or more processors to interpret the RPN encoding of the visual effects expression using an RPN interpreter.

Example 24: A computer program product for configuring visual appearances of graphical assets, the computer program product including instructions to obtain a set of dimensional parameters for a graphical asset of a user interface for an application executing at a computing device, the set of dimensional parameters indicating one or more values for a visual effects expression, the visual effects expression configured to output information associated with visual effects for the graphical asset; generate rendering parameters for graphic code associated with the application by at least providing the set of dimensional parameters as input to the visual effects expression, wherein the rendering parameters are associated with outputs of the visual effects expression and the rendering parameters indicate one or more visual effects; generate, based on the rendering parameters, the user interface to include the graphic code that configures a visual appearance of the graphical asset of the user interface according to the one or more visual effects indicated by the rendering parameters; and output, for display, the user interface.

Example 25: The computer program product of example 24, wherein the set of dimensional parameters include one or more of: one or more dimension values associated with the graphical asset, a density value associated with the graphical asset, time-based values associated with the application, or audio data associated with the application.

Example 26: The computer program product of any of examples 24 and 25, wherein to obtain the set of dimensional parameters, the instructions cause the at least one processor to obtain the set of dimensional parameters comprises obtaining the set of dimensional parameters from a development environment associated with the application.

Example 27: The computer program product of any of examples 24 through 26, wherein to obtain the set of dimensional parameters, the instructions cause the at least one processor to determine a time value and an amplitude value associated audio data output during execution of the application, and wherein the one or more visual effects include a ripple effect for a time indicator of the graphical asset.

Example 28: The computer program product of any of examples 24 through 27, wherein to generate the set of rendering parameters, the instructions cause the at least one processor to: determine, based on inputting the set of dimensional parameters into the visual effects expression, a state associated with the execution of the application; generate, based on the state being mapped to the one or more visual effects in configuration data associated with the application, the set of rendering parameters indicating the one or more visual effects; and input the rendering parameters in the graphic code.

Example 29: The computer program product of any of examples 24 through 28, wherein to generate the set of rendering parameters, the instructions cause the at least one processor to: input one or more outside inputs into the visual effects expression based on the one or more outside inputs being mapped to the set of dimensional parameters, wherein the one or more outside inputs indicate values associated with one or more of: time, theme color, or a sensor of the computing device.

Example 30: The computer program product of any of examples 24 through 29, wherein the set of dimensional parameters is a first set of dimensional parameters, and wherein the instructions further cause the at least one processor to: in response to generating the rendering parameters, store the rendering parameters as cached data; determine a second set of dimensional parameters; and in response to determining the second set of dimensional parameters correspond to the first set of dimensional parameters, access the cached data to generate the user interface.

Example 31: The computer program product of any of examples 24 through 30, wherein the set of dimensional parameters is a first set of dimensional parameters, the rendering parameters are a first set of rendering parameters, the one or more visual effects are a first set of visual effects, and the visual appearance is a first visual appearance, and wherein the instructions further cause the at least one processor to: obtain a second set of dimensional parameters; generate, based on inputting the second set of dimensional parameters into the visual effects expression, a second set of rendering parameters for the graphic code, the second set of rendering parameters indicating a second set of visual effects; and generate, based on the second set of rendering parameters, the user interface to include the graphic code that configures a second visual appearance of the graphical asset of the user interface according to the second set of visual effects indicated by the second set of rendering parameters.

Example 32: The computer program product of any of examples 24 through 31, wherein the one or more visual effects indicate graphical behaviors of the graphical asset including one or more of: a shape of the graphical asset, a color of the graphical asset, or an animation of the graphical asset.

Example 33: The computer program product of any of examples 24 through 32, wherein the instructions cause the at least one processor to obtain the graphic code from an application server hosting the application.

Example 34: The computer program product of any of examples 24 through 33, wherein the visual effects expression is encoded in Reverse Polish Notation (RPN), and wherein the instructions that cause the at least one processor to generate the rendering parameters comprise instructions that cause the at least one processor to interpret the RPN encoding of the visual effects expression using an RPN interpreter.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

Various examples have been described. These and other examples are within the scope of the following claims.

What is claimed is:

1. A method comprising:
obtaining, by a computing device, a set of dimensional parameters for a graphical asset of a user interface for an application executing at the computing device, the set of dimensional parameters indicating one or more values for a visual effects expression, the visual effects expression configured to output information associated with visual effects for the graphical asset;
generating, by the computing device, rendering parameters for graphic code associated with the application by at least providing the set of dimensional parameters as input to the visual effects expression, wherein the rendering parameters are associated with outputs of the visual effects expression and the rendering parameters indicate one or more visual effects;
generating, by the computing device and based on the rendering parameters, the user interface to include the graphic code that configures a visual appearance of the graphical asset of the user interface according to the one or more visual effects indicated by the rendering parameters; and
outputting, by the computing device and for display, the user interface.

2. The method of claim 1, wherein the set of dimensional parameters include one or more of: one or more dimension values associated with the graphical asset, a density value associated with the graphical asset, time-based values associated with the application, or audio data associated with the application.

3. The method of claim 1, wherein obtaining the set of dimensional parameters comprises obtaining the set of dimensional parameters from a development environment associated with the application.

4. The method of claim 1, wherein obtaining the set of dimensional parameters comprises determining a time value and an amplitude value associated audio data output during execution of the application, and wherein the one or more visual effects include a ripple effect for a time indicator of the graphical asset.

5. The method of claim 1, wherein generating the set of rendering parameters comprises:
determining, based on inputting the set of dimensional parameters into the visual effects expression, a state associated with the execution of the application;
generating, based on the state being mapped to the one or more visual effects in configuration data associated with the application, the set of rendering parameters indicating the one or more visual effects; and
inputting the rendering parameters in the graphic code.

6. The method of claim 1, wherein generating the set of rendering parameters further comprises inputting one or more outside inputs into the visual effects expression based on the one or more outside inputs being mapped to the set of dimensional parameters, wherein the one or more outside inputs indicate values associated with one or more of: time, theme color, or a sensor of the computing device.

7. The method of claim 1, wherein the set of dimensional parameters is a first set of dimensional parameters, and wherein the method further comprises:
in response to generating the rendering parameters, storing the rendering parameters as cached data;
determining a second set of dimensional parameters; and
in response to determining the second set of dimensional parameters correspond to the first set of dimensional parameters, accessing the cached data to generate the user interface.

8. The method of claim 1, wherein the set of dimensional parameters is a first set of dimensional parameters, the rendering parameters are a first set of rendering parameters, the one or more visual effects are a first set of visual effects, and the visual appearance is a first visual appearance, and wherein the method further comprises:
obtaining a second set of dimensional parameters;
generating, based on inputting the second set of dimensional parameters into the visual effects expression, a second set of rendering parameters for the graphic code, the second set of rendering parameters indicating a second set of visual effects; and
generating, based on the second set of rendering parameters, the user interface to include the graphic code that configures a second visual appearance of the graphical asset of the user interface according to the second set of visual effects indicated by the second set of rendering parameters.

9. The method of claim 1, further comprising generating, by a developer device, the graphic code as a single code file including the visual effects expression.

10. The method of claim 1, wherein the one or more visual effects indicate graphical behaviors of the graphical asset including one or more of: a shape of the graphical asset, a color of the graphical asset, or an animation of the graphical asset.

11. The method of claim 1, further comprising obtaining the graphic code from an application server hosting the application.

12. The method of claim 1, wherein the visual effects expression is encoded in Reverse Polish Notation (RPN), and wherein generating the rendering parameters comprises interpreting the RPN encoding of the visual effects expression using an RPN interpreter.

13. A device comprising:
a memory; and
one or more processors operably coupled to the memory, wherein the one or more processors execute instructions stored at the memory to:
obtain a set of dimensional parameters for a graphical asset of a user interface for an application executing at the device, the set of dimensional parameters indicating one or more values for a visual effects expression, the visual effects expression configured to output information associated with visual effects for the graphical asset;
generate rendering parameters for graphic code associated with the application by at least providing the set of dimensional parameters as input to the visual effects expression, wherein the rendering parameters are associated with outputs of the visual effects expression and the rendering parameters indicate one or more visual effects;
generate, based on the rendering parameters, the user interface to include the graphic code that configures a visual appearance of the graphical asset of the user interface according to the one or more visual effects indicated by the rendering parameters; and
output, for display, the user interface.

14. The device of claim 13, wherein the set of dimensional parameters include one or more of: one or more dimension values associated with the graphical asset, a density value associated with the graphical asset, time-based values associated with the application, or audio data associated with the application.

15. The device of claim 13, wherein to obtain the set of dimensional parameters, the one or more processors execute instructions stored at the memory to obtain the set of dimensional parameters comprises obtaining the set of dimensional parameters from a development environment associated with the application.

16. The device of claim 13, wherein to obtain the set of dimensional parameters, the one or more processors execute instructions stored at the memory to determine a time value and an amplitude value associated audio data output during execution of the application, and wherein the one or more visual effects include a ripple effect for a time indicator of the graphical asset.

17. The device of claim 13, wherein to generate the set of rendering parameters, the one or more processors execute instructions stored at the memory to:
determine, based on inputting the set of dimensional parameters into the visual effects expression, a state associated with the execution of the application;
generate, based on the state being mapped to the one or more visual effects in configuration data associated with the application, the set of rendering parameters indicating the one or more visual effects; and
input the rendering parameters in the graphic code.

18. The device of claim 13, wherein to generate the set of rendering parameters, the one or more processors execute instructions stored at the memory to: input one or more outside inputs into the visual effects expression based on the one or more outside inputs being mapped to the set of dimensional parameters, wherein the one or more outside inputs indicate values associated with one or more of: time, theme color, or a sensor of the device.

19. The device of claim 13, wherein the set of dimensional parameters is a first set of dimensional parameters, and wherein the one or more processors further execute instructions stored at the memory to:
in response to generating the rendering parameters, store the rendering parameters as cached data;
determine a second set of dimensional parameters; and
in response to determining the second set of dimensional parameters correspond to the first set of dimensional parameters, access the cached data to generate the user interface.

20. An apparatus comprising:
a processor; and
a computer-readable storage medium having stored instructions thereon that, responsive to execution by the processor, cause the processor to execute operations comprising:
obtain a set of dimensional parameters for a graphical asset of a user interface for an application executing at a computing device, the set of dimensional parameters indicating one or more values for a visual effects expression, the visual effects expression configured to output information associated with visual effects for the graphical asset;
generate rendering parameters for graphic code associated with the application by at least providing the set of dimensional parameters as input to the visual effects expression, wherein the rendering parameters are associated with outputs of the visual effects expression and the rendering parameters indicate one or more visual effects;
generate, based on the rendering parameters, the user interface to include the graphic code that configures a visual appearance of the graphical asset of the user interface according to the one or more visual effects indicated by the rendering parameters; and
output, for display, the user interface.
